(19) United States
(12) Patent Application Publication
(10) Pub. No.: US 2026/0364978 A1
(43) Pub. Date: Nov. 19, 2026

(54) TIRE MONITORING SENSOR

(71) Applicant: SENSATA TECHNOLOGIES, INC., ATTLEBORO, MA (US)

(72) Inventors: SAMUEL K. STRAHAN, BALLYMENA (GB); THOMAS J. O’BRIEN, RANDALSTOWN (GB); MARK DUFFY, ANTRIM (GB); MARK P. REILLY, LISBURN (GB)

(21) Appl. No.: 19/130,011

(22) PCT Filed: Nov. 15, 2023
(86) PCT No.: PCT/US2023/079758

§ 371 Date: May 14, 2025

Related U.S. Application Data
(60) Provisional application No. 63/425,346, filed on Nov. 15, 2022.

(51) Int. Cl. B60C 23/04; G01L 17/00

(52) U.S. Cl. CPC B60C 23/041; B60C 23/0447; B60C 23/0493; G01L 17/00

(57) ABSTRACT

Apparatuses and methods for manufacturing a tire monitoring sensors utilizing solid-state batteries are disclosed. In a particular embodiment, a tire monitoring sensor includes a sense element configured to measure one or more parameters of a tire. The tire monitoring sensor also includes a circuit board assembly electrically coupled to the sense element to receive, from the sense element, electrical signals indicating a measurement of the one or more parameters of the tire. In this embodiment, the tire monitoring sensor also includes a solid-state battery electrically coupled to the

### BACKGROUND

Advancements in tire monitoring sensors, such as tire pressure monitoring (TPM) sensors, see a migration away from conventional ultra-high frequency (UHF) communication towards Bluetooth Low Energy (BLE) technology. Moving to BLE technology provides two-way communications between a BLE-enabled control module in the vehicle and the BLE-enabled tire monitoring sensor. With this capability, advanced features can be added to the tire monitoring sensor. However, conventional tire monitoring sensors are limited by their battery technologies. Adding one or two of these advanced features may be possible with the conventionally-utilized battery technologies, but continuing to add advanced features is unsustainable unless battery improvements are made.

### SUMMARY

Apparatuses and methods of manufacturing a tire monitoring sensor that utilizes a solid-state battery are disclosed. The solid-state battery can take a variety of shapes depending on the application, and in some examples can include a through-hole, which is advantageous for tire pressure monitoring sensors. In some examples, the solid-state battery is surface-mounted onto a circuit board assembly. In some examples, the solid-state battery is rechargeable and coupled to an energy harvester for charging. This allows for the implementation of advanced features that would typically impart too much energy consumption on a conventional battery design.

In a particular embodiment, a tire monitoring sensor includes a sense element configured to measure one or more parameters of a tire. The tire monitoring sensor also includes a circuit board assembly electrically coupled to the sense element to receive, from the sense element, electrical signals indicating a measurement of the one or more parameters of the tire. In this embodiment, the tire monitoring sensor also includes a solid-state battery electrically coupled to the circuit board assembly.

In another embodiment, a method of manufacturing a tire monitoring sensor includes electrically coupling a sense element to a circuit board assembly and electrically coupling one or more solid-state batteries to the circuit board assembly.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a diagram of an example tire monitoring sensor for utilizing a solid-state battery according to at least one embodiment of the present disclosure.

FIG. 2 is a diagram of an example circuit board assembly of a tire monitoring sensor utilizing a solid-state battery according to at least one embodiment of the present disclosure.

FIG. 3A is a diagram of another example tire monitoring sensor for utilizing a solid-state battery according to at least one embodiment of the present disclosure.

FIG. 3B is an exploded view of the tire monitoring sensor of FIG. 3A.

FIG. 4A is a diagram of another example tire monitoring sensor for utilizing a solid-state battery according to at least one embodiment of the present disclosure.

FIG. 4B is a partially exploded view of the tire monitoring sensor of FIG. 4A.

FIG. 5 is a diagram of another example tire monitoring sensor for utilizing a solid-state battery according to at least one embodiment of the present disclosure.

FIG. 6 is a diagram of another example tire monitoring sensor for utilizing a solid-state battery according to at least one embodiment of the present disclosure.

FIG. 7 is a flowchart of an example method of manufacturing a tire monitoring sensor utilizing a solid-state battery according to at least one embodiment of the present disclosure.

FIG. 8 is a flowchart of an example method of manufacturing a tire monitoring sensor utilizing a solid-state battery according to at least one embodiment of the present disclosure.

FIG. 9 is a flowchart of an example method of manufacturing a tire monitoring sensor utilizing a solid-state battery according to at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Typical tire monitoring sensors, such as tire pressure monitoring sensors, utilize a cylindrical coin cell battery that is conventionally based on Lithium Manganese Dioxide (LiMnO₂) technology. While there have been improvements, the fundamental underlying technology has not changed significantly and hosts a number of disadvantages. For example, the coin cell batteries have a liquid-based electrolyte, which means that they must be mounted in a plane that is substantially parallel to the drop center of the wheel rim. A coin cell battery must also be tagged in order for the electrical connection to be made between the coin cell and the printed circuit board. These coin cells are also shipped in trays and require bespoke equipment to allow them to be soldered into the tire monitoring sensor housing.

A number of disadvantages of the conventional battery technology that is utilized in tire monitoring sensors are addressed by the present disclosure. Lithium Manganese Dioxide cells that are conventionally used cannot be surfaced mounted to a printed circuit board (PCB) because they cannot tolerate temperature excursions above 150 °C. These cells have a liquid electrolyte which means that they must be orientated in the product in a particular manner to allow homogenous discharge at high speed. Lithium Manganese Dioxide cells have a finite lifetime and cannot be recharged. These cells have a high self-discharge, especially at high temperatures. This effectively reduces the capacity available in the cell to support the power requirements of the application.

Lithium coin cells require specialized and expensive equipment to allow soldering between the PCB and the battery tag. This operation can lead to solder balls and short circuits. Coin cells require either expensive tags or battery holders to allow the electrical connection to be made between the cell and the PCB. Conventional lithium coin cells may not be able to supply the energy to enable the implementation of advanced features. These cells are made in very high volumes on highly automated production lines. Coin cells do not have form factors other than a disk-shape. In other words, the form factors of these cells are very inflexible.

In accordance with various embodiments, a tire monitoring sensor utilizing a solid-state battery is provided. A solid-state battery can conform to the shape of the printed circuit board of the tire monitoring sensor, and can be surfaced mounted to simplify the manufacturing process and at the same time to minimize the size of the tire monitoring sensor. In the case of a rechargeable solid-state battery, an energy harvester can be added to the tire monitoring sensor to allow recharging of the solid-state battery to extend battery lifetime. Improved sensor design, manufacturing processes, and battery lifetime that is provided by embodiments of the present disclosure support the addition of advanced features that are facilitated by two-way communication with a controller module.

In accordance with embodiments of the present disclosure, a tire monitoring sensor includes a solid-state battery that can be mounted on a PCB and can survive the high temperatures associated with surface mount reflow. Moving to a battery technology that can be surface mounted means that the bespoke soldering equipment associated with tire monitoring sensor manufacture can be removed. Batteries can be picked and placed like any other surface mount component. In some examples, the tire monitoring sensor includes a solid-state battery that is surface-mounted directly on a PCB and does not include any battery tags. Further, because the solid-state battery does not have a liquid electrolyte, there is no requirement for a specific orientation of the battery.

In some examples, the tire monitoring sensor includes a rechargeable solid-state battery. A rechargeable solid-state battery allows advanced functions to be implemented in the tire monitoring sensor. An energy harvester may be included for recharging the battery. During driving, the energy harvester can recharge the solid-state battery. The charged battery can also support any stationary mode functionality that is required.

Examples of the tire monitoring sensor include batteries of various form factor shapes. Thus, the battery form factor can be selected to conform to the profile of the PCB. This allows more freedom to design the tire monitoring sensor in a size and weight optimized manner. This is particularly important in applications where the tire monitoring sensor is mounted to the tire. In some examples, the tire monitoring sensor includes a donut-shaped battery that enables a very low-cost snap-in valve mounted sensor.

Whereas a conventional Lithium-ion battery is composed of cathode, anode, separator and a liquid electrolyte, a solid-state battery uses a solid electrolyte, which plays the role of a separator as well. A solid-state battery with a solid electrolyte improves stability and increases safety. A solid-state battery has higher energy density than a conventional Lithium-ion battery that uses liquid electrolyte solution. Because the risk of explosion or fire is lower, typical safety measures that must be included in conventional Lithium-ion batteries can be omitted, thus saving space. Further, a solid-state battery has a reduced self-discharge rate compared to Lithium Manganese Dioxide technology.

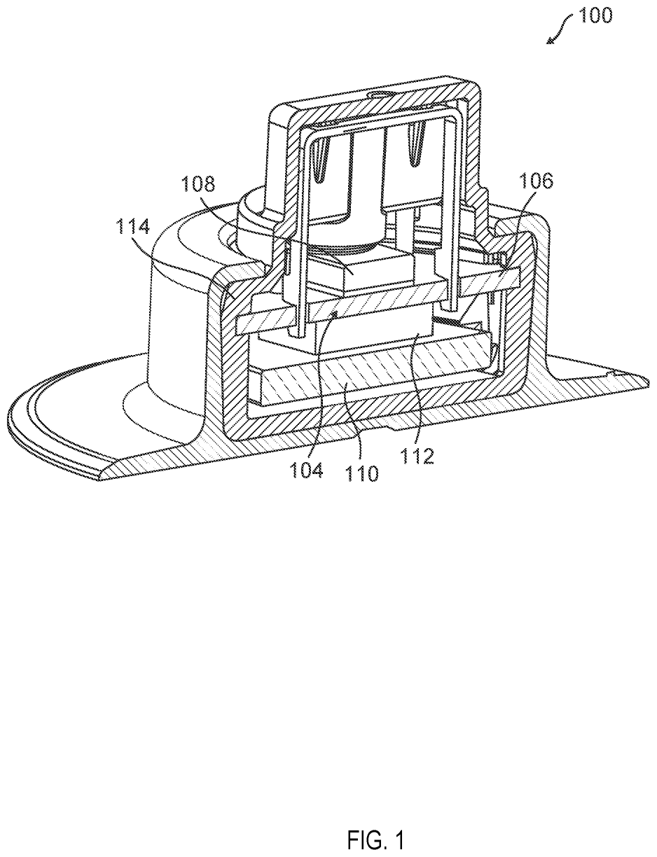

For further explanation, FIG. 1 sets forth a diagram illustrating a sectional view an example tire monitoring sensor 100 in accordance with at least one embodiment of the present disclosure. The tire monitoring sensor 100 includes a sense element (not shown) electrically coupled to a circuit board assembly 104. The sense element may be a pressure sensing element, a temperature sensing element, an accelerometer, a shock sensor, or the like, that measures characteristics of a tire. In some examples, the sense element is surface-mounted on the circuit board assembly 104. In other examples, the sense element is connected to the circuit board assembly 104 by wire leads, solder structures, springs, or some other conductive structure that conveys electrical signals generated by the sense element to components of the circuit board assembly 104. In some examples, the circuit board assembly 104 includes a printed circuit board (PCB) 106 on which a variety of electronic components are disposed. In a particular example, an integrated circuit 108 is surface-mounted on the PCB 106 of the circuit board assembly 104. For example, the integrated circuit 108 may be an application specific integrated circuit (ASIC) configured to process signals received from the sense element. In a particular example, where the sense element is a pressure sensing element, the integrated circuit 108 is configured to process signals generated by the sense element and generate pressure data that can be transmitted to a controller, such as a tire pressure monitoring system controller. For example, the pressure information can be transmitted via a wireless transceiver using the BLE protocol to a connected controller. The wireless transceiver may be disposed on the PCB 106 of the circuit board assembly 104.

The example tire monitoring sensor 100 further includes a solid-state battery 110 that is electrically coupled to the circuit board assembly 104 to provide power to the components of the circuit board assembly 104, such as the sense element, integrated circuit 108, transceiver, and so on. In some examples, the solid-state battery 110 is a rechargeable battery. In such examples, an energy harvester 112 is coupled to the solid-state battery 110 to recharge the solid-state battery 110. For example, the energy harvester 112 may utilize the motion of the tire to generate a charge that can be stored by the solid-state battery 110.

Readers of skill in the art will recognize that a variety of types of energy harvesting may be utilized, including vibration energy harvesting, piezoelectric energy harvesting, thermal energy harvesting, and so on.

The example tire monitoring sensor 100 also includes a housing 114. The sense element, circuit board assembly 104, integrated circuit 108, solid-state battery 110, and energy harvester 112 are disposed within the housing 114. In one example, as shown in FIG. 1, the tire monitoring sensor 100 is a tire mounted sensor, and the housing 114 fits into a deformable molding that is couplable to the tire.

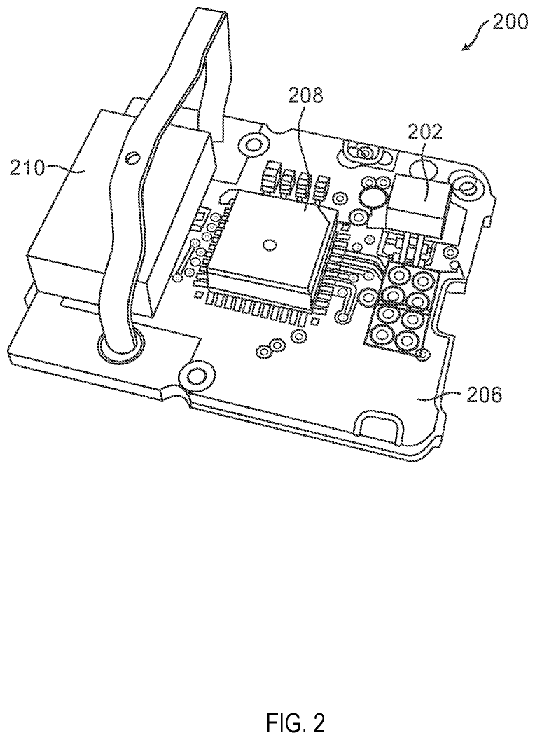

For further explanation, FIG. 2 sets forth a diagram illustrating a perspective view an example circuit board assembly 200 for a tire monitoring sensor in accordance with at least one embodiment of the present disclosure. The circuit board assembly 200 includes a solid-state battery 210 that is surface-mounted on the PCB 206 of the circuit board assembly 200. The circuit board assembly 200 also includes a sense element 202 that is surface-mounted on the PCB 206. The sense element 202 may be a pressure sensing element, a temperature sensing element, an accelerometer, a shock sensor, or the like, that measures characteristics of a tire. In one example, the sense element 202 is a pressure sensing element that measures tire pressure. The circuit board assembly 200 also includes an integrated circuit 208. For example, the integrated circuit 108 may be an ASIC configured to process signals received from the sense element and generate data for wireless transmission to a remote controller, such as vehicle control system module.

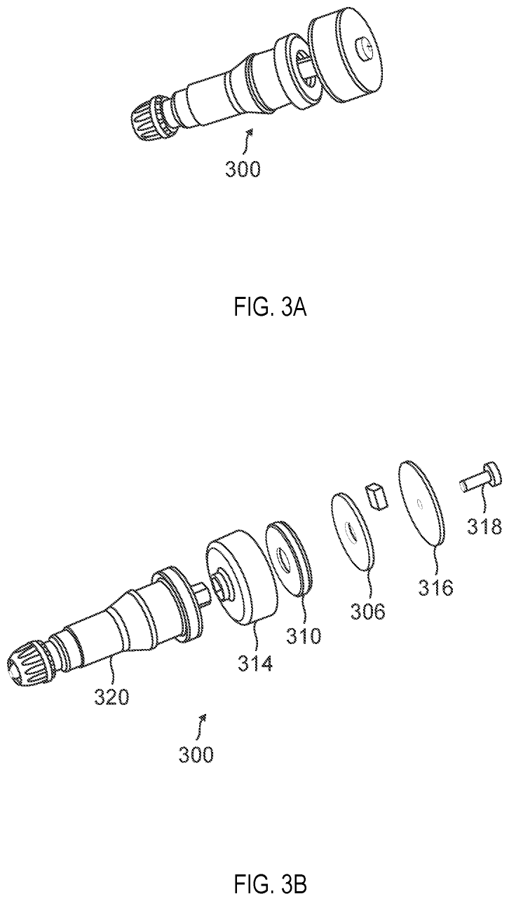

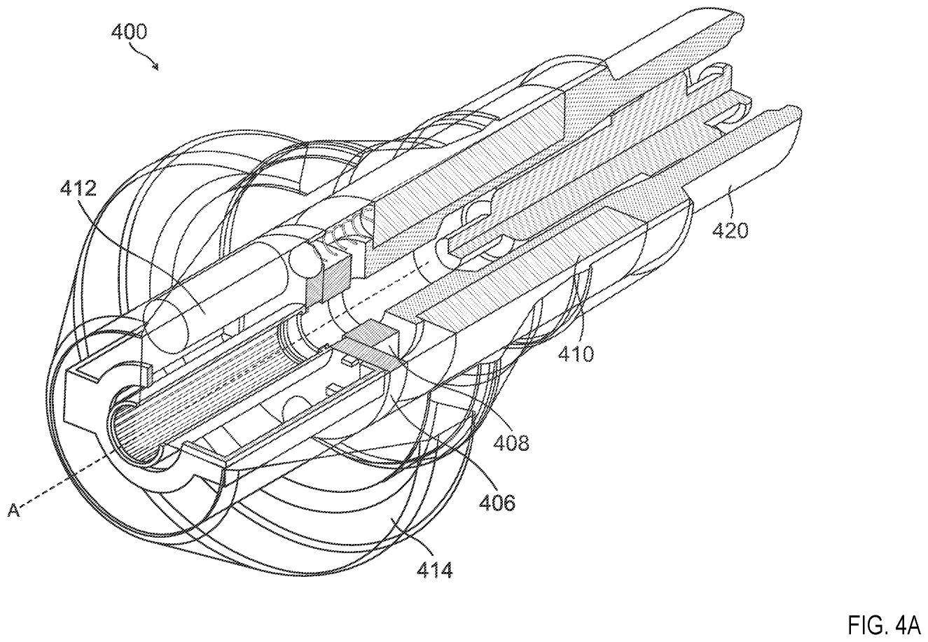

For further explanation, FIG. 3A sets forth a diagram illustrating a perspective view an example tire monitoring sensor 300 in accordance with at least one embodiment of the present disclosure. In the example of FIG. 3A, the tire monitoring sensor 300 is a valve-mounted tire monitoring sensor, such as a valve-mounted tire pressure monitoring sensor. FIG. 3B sets forth an exploded view of the tire monitoring sensor 300 of FIG. 3A. Referring to FIG. 3B, the tire monitoring sensor 300 includes a tire pressure monitoring valve 320 and an enclosure 314. A disk-shaped solid-state battery 310 and a disk-shaped circuit board assembly 306 are disposed within the enclosure 314 such that through-holes or apertures in the disk-shaped solid-state battery 310 and the disk-shaped circuit board assembly 306 are in alignment. An integrated circuit 308, such as an ASIC, is mounted on the PCB and configure to receive signals from a pressure sensing element (not shown). The enclosure includes a lid 316. A retaining screw 318 couples the enclosure 314 to the tire pressure monitoring valve 320. Although not depicted, the tire monitoring sensor 300 may also include an energy harvester where the disk-shaped solid-state battery 310 is rechargeable via the energy harvester.

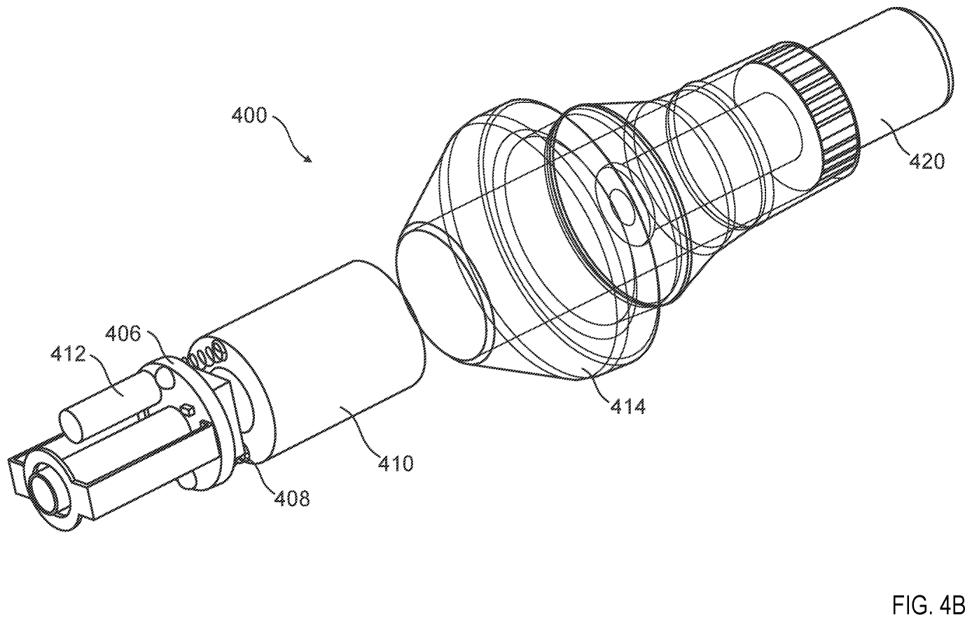

For further explanation, FIG. 4A sets forth a diagram illustrating a perspective sectional view an example tire monitoring sensor 400 in accordance with at least one embodiment of the present disclosure. In the example of FIG. 4A, the tire monitoring sensor 400 is a valve-mounted tire monitoring sensor, such as a valve-mounted tire pressure monitoring sensor. The example tire monitoring sensor 400 includes a stem member 420 extending through an aperture or through-hole in a cylindrical solid-state battery 410. The cylindrical solid-state battery 410 is electrically coupled via conductive springs to contacts of a disk-shaped circuit board assembly 406. An integrated circuit 408 is surface-mounted on the circuit board assembly 406. For example, the integrated circuit 408 may be an ASIC configured to process signals from a pressure sense element. A through-hole in the integrated circuit 408 and a through-hole in the disk-shaped circuit board assembly 406 concentrically align with the through-hole of cylindrical solid-state battery 410 and a shaft in the stem member 420 along axis A, such that an air channel extends the length of the tire monitoring sensor 400 along axis A. The tire monitoring sensor 400 also includes an energy harvester 412 coupled to a side of the disk-shaped circuit board assembly 406 opposite the integrated circuit 408. The energy harvester 412 may be electrically coupled to the cylindrical solid-state battery 410 via the disk-shaped circuit board assembly 406. An over-molded rubber enclosure 414 (depicted as semi-transparent for clarity) covers the disk-shaped circuit board assembly 406, integrated circuit 408, cylindrical solid-state battery 410, energy harvester 412, and other components, and partially covers the stem member 420. FIG. 4B sets forth an exploded view of the tire monitoring sensor 400 of FIG. 4A in which the disk-shaped circuit board assembly 406, integrated circuit 408, cylindrical solid-state battery 410, energy harvester 412, and other components are decoupled form the over-molded rubber enclosure 414.

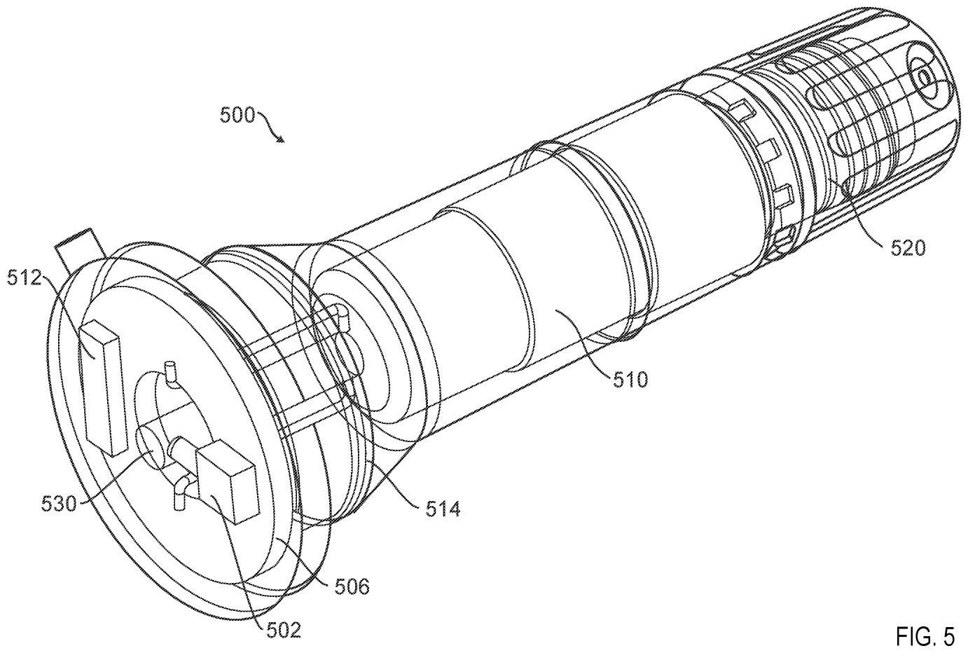

For further explanation, FIG. 5 sets forth a diagram illustrating a perspective view an example tire monitoring sensor 500 in accordance with at least one embodiment of the present disclosure. The tire monitoring sensor 500 includes a cylindrical solid-state battery 510 electrically coupled via leads to a disk-shaped circuit board assembly 506. The cylindrical solid-state battery 510 includes a through-hole extending axially through the center of the cylindrical solid-state battery 510. An energy harvester 512 and a sense element 502 are surface-mounted on a side of the circuit board assembly 506 opposite the cylindrical solid-state battery 510. An air shaft 530 extends through the through-hole of the cylindrical solid-state battery 510 and along the length of the tire monitoring sensor 500, thus allowing air to pass into the tire monitoring sensor 500 such that an air pressure measurement may be registered by the sense element 502. The cylindrical solid-state battery 510 is further coupled to a stem member 520. An over-molded rubber enclosure 514 (depicted as semi-transparent for clarity) covers the disk-shaped circuit board assembly 506, cylindrical solid-state battery 510, energy harvester 512, sense element 502, and other components.

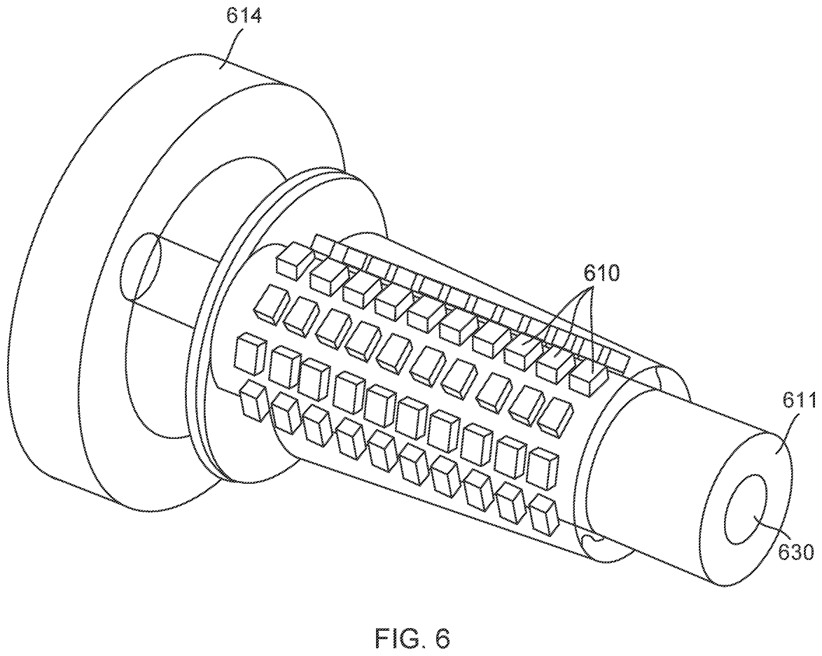

For further explanation, FIG. 6 sets forth a diagram illustrating a perspective view an example tire monitoring sensor 600 in accordance with at least one embodiment of the present disclosure. The tire monitoring sensor 600 includes a cylindrical body 611 within an enclosure 614. In this embodiment, an array 610 of solid-state batteries are mounted to the outer surface of the cylindrical body 611. The cylindrical body 611 includes a through-hole extending axially through the center of the cylindrical body 611. Although not picture in FIG. 6, a sense element, circuit board assembly, and an energy harvester, as described in other embodiments, may be fitted around the through-hole. In this embodiment, the array 610 of solid-state batteries may be coupled to a circuit board assembly. An air shaft 630 extends through the through-hole of the cylindrical body 611 and along the length of the tire monitoring sensor 600, thus allowing air to pass into the tire monitoring sensor 600 such that an air pressure measurement may be registered by a sense element. The cylindrical body 611 may be further coupled to a stem member (not shown).

The examples in the above-described figures include an integrated circuit configured to process signals from a sense element and generate data for wireless transmission to a remote controller, such as vehicle control system module. The examples in the above-described figures include a wireless transceiver and an antenna for bidirectional communication with a remote controller, such as vehicle control system module. The bidirectional communications channel allows the tire monitoring sensor to transmit sensor data and to receive information the remote controller including parameters used in the configuration or operation of the tire monitoring sensor. In some examples, the bidirectional communications channel utilizes the BLE protocol.

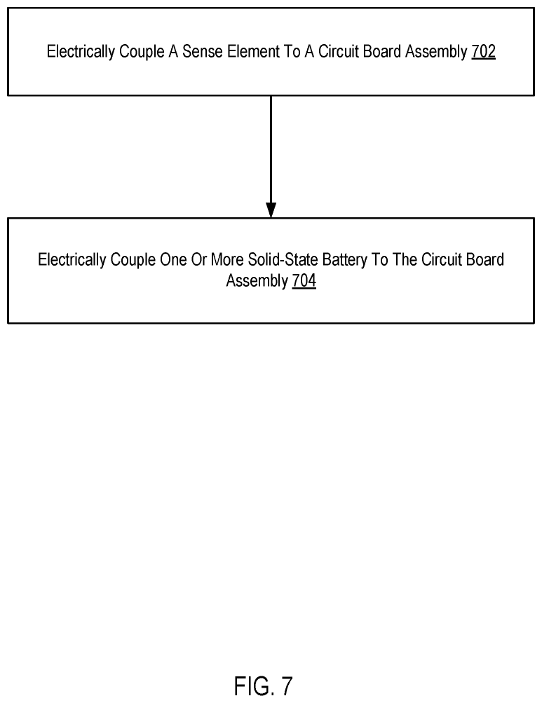

For further explanation, FIG. 7 sets forth a flow chart illustrating an example method of manufacturing a tire monitoring sensor in accordance with at least one embodiment of the present disclosure. The method of FIG. 7 includes electrically coupling 702 a sense element to a circuit board assembly. For example, the sense element can be surface-mounted on the circuit board assembly or connected by leads or wiring. The sense element may be any of the sense elements discussed above with reference to the figures. The circuit board assembly may be any of the circuit board assemblies discussed above with reference to the figures. The method of FIG. 7 also includes electrically coupling 704 one or more solid-state batteries to the circuit board assembly. The solid-state battery may be any of the solid-state batteries discussed above with reference to the figures. In various examples, the solid-state battery is coupled to the circuit board assembly via wires, leads, conductive springs, and so on. In other examples, the solid-state battery is coupled to the circuit board assembly by surface-mounting the solid-state battery on the circuit board assembly. In still further examples, the solid-state battery is coupled to the circuit board assembly by pressure-fitting the solid-state battery against the circuit board assembly.

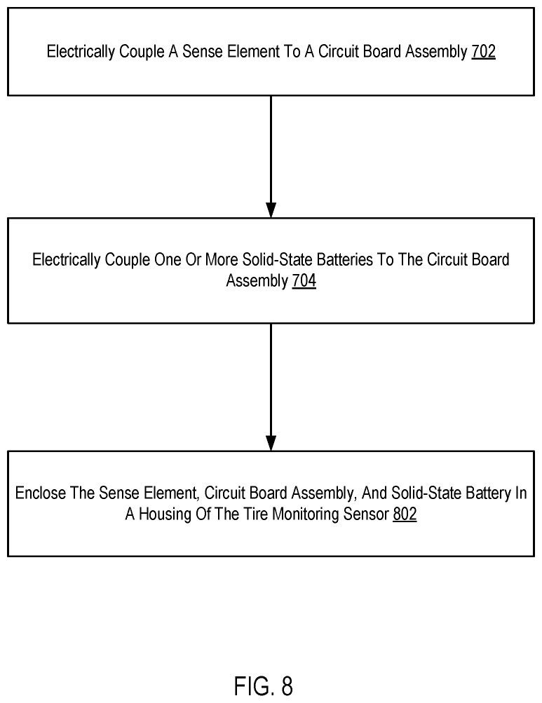

For further explanation, FIG. 8 sets forth a flow chart illustrating an example method of manufacturing a tire monitoring sensor in accordance with at least one embodiment of the present disclosure. The method of FIG. 8 includes all the steps of FIG. 7. In addition, the method of FIG. 8 also includes enclosing 706 the sense element, circuit board assembly, and solid-state battery in a housing of the tire monitoring sensor. Enclosing 706 the sense element, circuit board assembly, and the one or more solid-state batteries in a housing of the tire monitoring sensor may be carried out applying a rubber mold around the components of the tire monitoring sensor to form an enclosure.

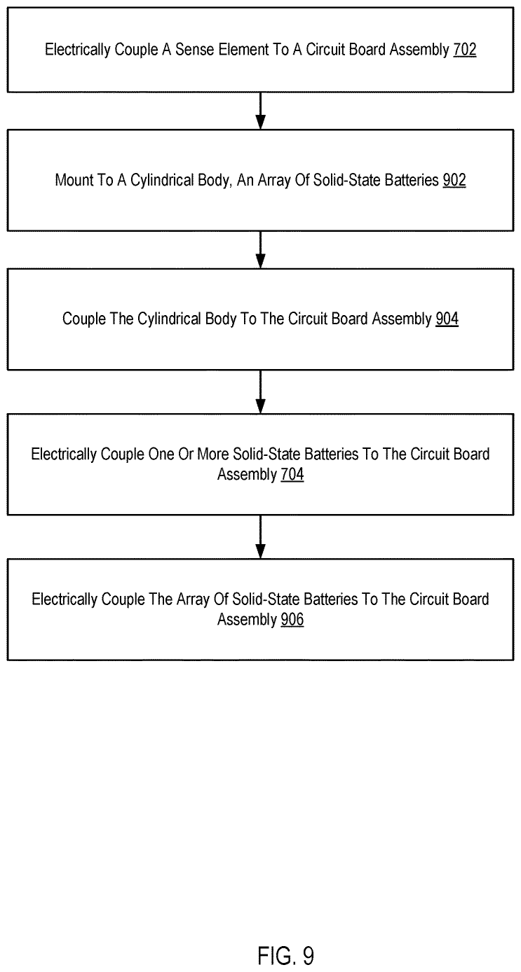

For further explanation, FIG. 9 sets forth a flow chart illustrating an example method of manufacturing a tire monitoring sensor in accordance with at least one embodiment of the present disclosure. The method of FIG. 9 includes all the steps of FIG. 7. In addition, the method of FIG. 9 also includes mounting 902 to a cylindrical body, an array of solid-state batteries. Mounting 902 to a cylindrical body, an array of solid-state batteries may be carried out by soldering, gluing, or otherwise attaching each solid-state battery of the array of solid-state batteries to the cylindrical body. The method of FIG. 9 also includes coupling 904 the cylindrical body to the circuit board assembly. Coupling 904 the cylindrical body to the circuit board assembly may be carried out by gluing or soldering the circuit board assembly to the cylindrical body. The method of FIG. 9 also includes electrically coupling 906 the array of solid-state batteries to the circuit board assembly. Electrically coupling 906 the array of solid-state batteries to the circuit board assembly may be carried out by soldering or attaching leads from the solid-state batteries to one or more connections on the circuit board assembly.

The flowchart and block diagrams in the Figures illustrate the architecture, functionality, and operation of possible implementations of systems, apparatuses, and methods according to various embodiments of the present invention. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to embodiments, those skilled in the art will readily appreciate that various changes and/or modifications can be made to the subject technology without departing from the spirit or scope of the subject technology. For example, each claim may depend on any or all claims in a multiple dependent manner even though such has not been originally claimed.

Advantages and features of the present disclosure can be further described by the following statements:
1. A tire monitoring sensor comprising: a sense element configured to measure one or more parameters of a tire; a circuit board assembly electrically coupled to the sense element to receive, from the sense element, electrical signals indicating a measurement of the one or more parameters of the tire; and a solid-state battery electrically coupled to the circuit board assembly.
2. The tire monitoring sensor of statement 1 wherein the circuit board assembly includes a wireless transceiver configured to transmit data indicating the measurement of the one or more parameters of the tire.
3. The tire monitoring sensor of statement 1 or 2 further comprising: an energy harvester electrically coupled to the solid-state battery, the energy harvester configured to generate an electrical charge and store the generated electrical charge on the sold-state battery.
4. The tire monitoring sensor of any of statements 1-3, wherein the energy harvester is mounted on the circuit board assembly.
5. The tire monitoring sensor of any of statements 1-4, wherein the solid-state battery is mounted on the circuit board assembly.
6. The tire monitoring sensor of any of statements 1-5 further comprising: a cylindrical body; and an array of solid-state batteries that include the solid-state battery; the array of solid-state batteries mounted on the cylindrical body.
7. The tire monitoring sensor of any of statements 1-6, wherein the solid-state battery includes a through-hole.
8. The tire monitoring sensor of any of statements 1-7, wherein the through-hole of the solid-state battery aligns with a through-hole of the circuit board assembly.
9. The tire monitoring sensor of any of statements 1-8, wherein the through-hole of the solid-state battery and the through-hole of the circuit board assembly align with an air channel extending through the tire monitoring sensor.
10. The tire monitoring sensor of any of statements 1-9, wherein the solid-state battery is disk-shaped.
11. The tire monitoring sensor of any of statements 1-10, wherein the solid-state battery is cylindrical.
12. The tire monitoring sensor of any of statements 1-11, wherein the sense element is a pressure sense element.
13. The tire monitoring sensor of any of statements 1-12, wherein the sense element is mounted on the circuit board assembly.
14. The tire monitoring sensor of any of statements 1-13, wherein the sense element, circuit board assembly, and solid-state battery are enclosed in a housing of the tire monitoring sensor; wherein the tire monitoring sensor is mountable on a tire.
15. The tire monitoring sensor of any of statements 1-14, wherein the sense element, circuit board assembly, and solid-state battery are enclosed in a housing of the tire monitoring sensor; wherein the tire monitoring sensor is valve-mountable.
16. The tire monitoring sensor of any of statements 1-15, wherein the circuit board assembly includes an integrated circuit configured to process the electrical signals received from the sense element.
17. A method of manufacturing a tire monitoring sensor, the method comprising: electrically coupling a sense element to a circuit board assembly; and electrically coupling one or more solid-state batteries to the circuit board assembly.

18. The method of statement 17 further comprising enclosing the sense element, the circuit board assembly and the one or more solid-state batteries in a housing of the tire monitoring sensor.

19. The method of statement 17 or 18, wherein the solid-state battery is mounted on the circuit board assembly.

20. The method of any of statements 17-19 further comprising: mounting to a cylindrical body, an array of solid-state batteries that include the solid-state battery; coupling the cylindrical body to the circuit board assembly; and electrically coupling the array of solid-state batteries to the circuit board assembly.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A tire monitoring sensor comprising:
a sense element configured to measure one or more parameters of a tire;
a circuit board assembly electrically coupled to the sense element to receive, from the sense element, electrical signals indicating a measurement of the one or more parameters of the tire; and
a solid-state battery electrically coupled to the circuit board assembly.

2. The tire monitoring sensor of claim 1 wherein the circuit board assembly includes a wireless transceiver configured to transmit data indicating the measurement of the one or more parameters of the tire.

3. The tire monitoring sensor of claim 1 further comprising:
an energy harvester electrically coupled to the solid-state battery, the energy harvester configured to generate an electrical charge and store the generated electrical charge on the sold-state battery.

4. The tire monitoring sensor of claim 3, wherein the energy harvester is mounted on the circuit board assembly.

5. The tire monitoring sensor of claim 1, wherein the solid-state battery is mounted on the circuit board assembly.

6. The tire monitoring sensor of claim 1 further comprising:
a cylindrical body; and
an array of solid-state batteries that include the solid-state battery; the array of solid-state batteries mounted on the cylindrical body.

7. The tire monitoring sensor of claim 1, wherein the solid-state battery includes a through-hole.

8. The tire monitoring sensor of claim 7, wherein the through-hole of the solid-state battery aligns with a through-hole of the circuit board assembly.

9. The tire monitoring sensor of claim 8, wherein the through-hole of the solid-state battery and the through-hole of the circuit board assembly align with an air channel extending through the tire monitoring sensor.

10. The tire monitoring sensor of claim 7, wherein the solid-state battery is disk-shaped.

11. The tire monitoring sensor of claim 7, wherein the solid-state battery is cylindrical.

12. The tire monitoring sensor of claim 1, wherein the sense element is a pressure sense element.

13. The tire monitoring sensor of claim 1, wherein the sense element is mounted on the circuit board assembly.

14. The tire monitoring sensor of claim 1, wherein the sense element, circuit board assembly, and solid-state battery are enclosed in a housing of the tire monitoring sensor; wherein the tire monitoring sensor is mountable on a tire.

15. The tire monitoring sensor of claim 1, wherein the sense element, circuit board assembly, and solid-state battery are enclosed in a housing of the tire monitoring sensor; wherein the tire monitoring sensor is valve-mountable.

16. The tire monitoring sensor of claim 1, wherein the circuit board assembly includes an integrated circuit configured to process the electrical signals received from the sense element.

17. A method of manufacturing a tire monitoring sensor, the method comprising:
electrically coupling a sense element to a circuit board assembly; and
electrically coupling one or more solid-state batteries to the circuit board assembly.

18. The method of claim 17 further comprising enclosing the sense element, the circuit board assembly and the one or more solid-state batteries in a housing of the tire monitoring sensor.

19. The method of claim 17, wherein the solid-state battery is mounted on the circuit board assembly.

20. The method of claim 17 further comprising:
mounting to a cylindrical body, an array of solid-state batteries that include the solid-state battery;
coupling the cylindrical body to the circuit board assembly; and
electrically coupling the array of solid-state batteries to the circuit board assembly.
